(19) United States
(12) Patent Application Publication
(10) Pub. No.: US 2017/0262889 A1
(43) Pub. Date: Sep. 14, 2017

(54) Methods and Devices for Identifying a Merchant

(71) Applicant: MASTERCARD INTERNATIONAL INCORPORATED, Purchase, NY (US)

(72) Inventors: Arunmurthy Gurunathan, Pune (IN); Kalyan Kommanapalli, Flemish Brabant (BE)

(21) Appl. No.: 15/451,527

(22) Filed: Mar. 7, 2017

(30) Foreign Application Priority Data
Mar. 9, 2016 (SG) 10201601836X

(51) Int. Cl. G06Q 30/02

(52) U.S. Cl. CPC G06Q 30/0261; G06F 17/30241

(57) ABSTRACT

Methods and devices are provided for identifying a merchant and making a reservation with the merchant. In one aspect, a method is provided utilizing a communication device configured for (a) receiving navigation data associated with a user; (b) upon receiving an activation signal, generating an electronic request using the activation signal and the navigation data, the electronic request encoding a request for goods or services corresponding to the activation signal; (c) transmitting the electronic request to a computer server to obtain merchant information of one or more candidate merchants; (d) receiving the merchant information, the merchant information including geographic locations of the one or more candidate merchants. In further aspects, a communication device is provided which has a processor and a data storage device storing computer program instructions; and, a computer server for handling an electronic request to identify a relevant merchant and an associated method are also provided.

### FIELD AND BACKGROUND

This present disclosure relates to methods and devices for identifying a merchant which supplies goods or services. In particular, computerized-methods and devices for identifying a merchant supplying goods or services which is relevant to a user are provided.

Various methods are used for identifying potential merchants and making a reservation for goods or services. For example, a user performs a search (e.g. using the internet) of merchants who supplies the type of goods or services in a certain geographic region. The user then identifies the merchant of interest based on the search result and contacts the merchant, for example, by a phone call to enquire and/or make a reservation with the merchant. Sometimes the search returns the relevant merchants which are nearby, such as when a mobile-phone user allows his current location to be used for the search. Then the user contacts the merchant of interest to make a reservation for goods or services by querying an available time slot.

However, existing methods are still cumbersome as it requires the user specify search terms (such as “car service centers”) in order to retrieve information about relevant merchants based on a geographic location. It is desirable to provide an improved method and device for identifying a merchant and optionally making a reservation with the merchant.

### SUMMARY

The present disclosure provides a device and method for identifying a merchant where a user is en route to a destination location. In general terms, the present disclosure proposes identifying relevant merchants based on an electronic request encoding assistance required and a destination location associated with the user. Typically but not necessarily, the relevant merchants are identified based on their availability information. Optionally, the proposed method may include an optional step of making a reservation with an available merchant so that the user will be able to access to the type of goods or services of his/her needs expeditiously and efficiently.

According to a first aspect, there is provided a communication device such as a mobile phone, or a GPS unit for use with a vehicle. The communication device has a processor and a data storage device storing computer program instructions, the computer program instructions being operative, to cause the processor to:
(a) receive navigation data associated with a user, said navigation data comprising a first and second geographic location;
(b) upon receiving an activation signal, generate an electronic request using the activation signal and the navigation data, said electronic request encoding a request for goods or services corresponding to the activation signal;
(c) transmit the electronic request to a computer server to obtain merchant information of one or more candidate merchants; and
(d) receive the merchant information of the one or more candidate merchants, the merchant information comprising a geographic location of the candidate merchant.

This could be useful for a user to identify and locate a relevant merchant for the goods or services desired by the user, especially when the goods or service is needed urgently, and/or where an emergency service is needed when the user is en route to a pre-determined destination location. For example, when a user is (or about to) en route to a destination location, an urgent need for assistance becomes apparent along the journey, the user can be provided with relevant choices of available merchants for the goods or services identified based on the geographic location associated with the user. This makes it possible to minimize any detour in terms of travelling time and/or distance en route to the user's destination location. For example, the available merchants may be recommended to the user based on the starting (or current) location and the destination location that is previously entered by the user before the trip started.

Alternatively or additionally, the available merchants may be recommended to the user based on a specific route connecting the starting and destination location previously chosen by the user among different possible routes.

Typically but not necessarily, the merchant information comprises availability data about the one or more candidate merchants. The availability data is indicative of the candidate merchant's capacity in providing the goods or services during a pre-defined time slot, such as within the next 10 minutes, 20 minutes, 30 minutes, or 1 hour. This may provide the user with useful information regarding availability and/or expected waiting time needed before receiving goods/services from the merchant, which allows the user to make an informed decision about the merchant the user would like to select.

In one embodiment, the data storage device may store computer program instructions operative to cause the processor to:
(e) register a selection among the one or more candidate merchants by the user; and
(f) cause a reservation request to be transmitted to a merchant's server in response to the selection.

This may allow the user to secure a reservation for the goods or services needed by the user with the selected merchant. Therefore, the user may receive the goods/services at the merchant with minimal waiting time. Thus, this also minimizes any additional travelling time or distance as a result of the user having to switch to another merchant due to the unavailability of the present merchant.

In one embodiment, the communication device may comprise a positioning unit configured to determine a geographic location of the communication device and operation (a) may comprise receiving the first geographic location from the positioning unit. The geographic location may be represented by, for example, a postal code or a pair of geographic coordinates.

In one embodiment, the activation signal may be generated by a sensor unit communicatively coupleable to the communication device. For example, the sensor unit may include a vehicle sensor coupled to a vehicle and said activation signal may be generated upon a pre-defined condition of the vehicle being detected by the vehicle sensor. The pre-defined condition may be indicative of a need for vehicle maintenance. Upon the communication device receiving the activation signal, it automatically generates the electronic request which is transmitted automatically to the computer server. For another example, the sensor unit may be configured to measure a physical parameter of the user, and the activation signal may be automatically generated upon the measured physical parameter exceeding a pre-defined range.

In another embodiment, the activation signal may be generated by an input actively initiated by the user, such as the user manually input through the input/output device requesting a type of goods or services.

In one embodiment, each of the candidate merchants is identified using its geographic location and the electronic request. According to a particular example, each of the candidate merchants may be identified based on a distance between its geographic location and a route connecting the first and second geographic location.

In one embodiment, the data storage device may store computer program instructions operative to cause the processor to receive personal information of the user, and the electronic request is generated further using the personal information. Additionally or alternatively, the reservation request may comprise the personal information. The personal information may, for example, comprise at least one of (i) payment information associated with the user, (ii) an identity of the user, and (iii) an age of the user.

The communication device may be configured to further assist with a payment transaction with the merchant for the goods or services provided to the user.

In one embodiment, the data storage device may store computer program instructions operative to cause the processor to:
(g) receive a bill, from the merchant's server, for the goods or services supplied to the user; and
(h) upon an authorization by the user, cause a payment transaction to be processed by a payment network server to effect a payment for the bill.

The bill may comprise a first and second payment amount to be received from the user and a third party respectively, and the payment transaction is for the first payment amount, i.e. the payment receivable from the user. In one embodiment, the communication device may be configured to cause a payment transaction for the second amount to be processed by a payment network server.

In a further embodiment, the communication device may be configured to determine a navigation route which connects the first, second and merchant's geographic location.

According to a second aspect, there is provided a computer-implemented method of identifying a merchant. The method comprising a communication device:
(a) receiving navigation data associated with a user, said navigation data comprising a first and second geographic location;
(b) upon receiving an activation signal, generating an electronic request using the activation signal and the navigation data, said electronic request encoding a request for goods or services corresponding to the activation signal;
(c) transmitting the electronic request to a computer server to obtain merchant information of one or more candidate merchants; and
(d) receiving the merchant information of the one or more candidate merchants, the merchant information comprising a geographic location of the candidate merchant.

In one embodiment, the merchant information comprises availability data about the one or more candidate merchants. The availability data may be indicative of the candidate merchant's capacity in providing the goods or services during a pre-defined time slot.

The computer-implemented method may further comprise operations which the communication device is configured to perform as described above.

The present disclosure may alternatively be expressed in terms of the software product itself, such as at a time when it is stored in a non-transitory form on a tangible data storage device. The data storage device may be within the communication device, or it may be a database from which the communication device is able to download the software application. In particular, there is proposed a computer program product comprising computer program instructions which is operative, when implemented by a processor of a communication device, to cause the processor to:
(a) receive navigation data associated with a user, said navigation data comprising a first and second geographic location;
(b) upon receiving an activation signal, generate an electronic request using the activation signal and the navigation data, said electronic request encoding a request for goods or services corresponding to the activation signal;
(c) transmit the electronic request to a computer server to obtain merchant information of one or more candidate merchants; and
(d) receive the merchant information of the one or more candidate merchants, the merchant information comprising a geographic location of the candidate merchant.

According to a further aspect, there is provided a computer server for processing a reservation request. The computer server comprises a server processor, and a data storage device storing server processor program instructions. The server processor program instructions are operative to cause the server processor to:
(a) receive an electronic request from a communication device of a user, said electronic request encoding a request for goods or services and navigation data associated with the user, said navigation data comprising a first and second geographical location;
(b) interrogate a first database storing merchants information to identify one or more candidate merchants using its geographic location and the electronic request; and
(c) transmit the merchant information of the one or more candidate merchants to the communication device, the merchant information comprising a geographic location of the candidate merchant.

In one embodiment, the merchants information comprises availability data about the one or more candidate merchants. The availability data may be indicative of the candidate merchant's capacity in providing the goods or services during a pre-defined time slot.

In one embodiment, the data storage device further stores server processor program instructions operative to cause the server processor to:
(d) receive, from the communication device, data indicative of a selection among the one or more candidate merchants by the user; and
(e) transmit a reservation request to a merchant's server in response to the selection.

In one embodiment, operation (b) may comprise identifying the one or more candidate merchants based on a distance between its geographic location and a route connecting the first and second geographic location.

In one embodiment, the one or more candidate merchants may be identified by the server processor further interrogating a second database storing promotion information associated with merchants to supply goods or services. The promotional information may be (i) offers by merchants to supply goods or services, and/or (ii) privileges available for payments made with a pre-define range of payment cards.

In one embodiment, the one or more candidate merchants may be identified by the server processor further interrogating a third database storing information about third parties, for example, the third parties who offer payments for the goods or services supplied to the user.

In one embodiment, the data storage device may store server processor program instructions operative to cause the server processor to receive personal information of the user and the electronic request may be generated further using the personal information. In one embodiment, the reservation request may comprise the personal information of the user. The personal information may be (i) payment information associated with the user, (ii) an identity of the user, and/or (iii) an age of the user.

In one embodiment, the data storage device may store server processor program instructions operative to cause the server processor to:
(f) receive a bill, from the merchant's server, for the goods or services supplied to the user,
(g) determine a first amount receivable from the user, and
(i) transmit, to the communication device, a request for a payment of the first amount.

In one embodiment, operation (g) may further comprise receiving insurance data associated with the user and determining a second amount receivable from an insurance provider. The first amount is a difference between the bill and the second amount.

In one embodiment, the data storage device may store server processor program instructions operative to cause the server processor to transmit, to a server of the insurance provider, a request for a payment of the second amount.

According to a further aspect, there is provided a computer-implemented method for identifying a merchant. The method comprises a computer server performing the operations of:
(a) receiving, by the computer server, an electronic request from a communication device of a consumer, said electronic request encoding a request for goods or services and navigation data associated with the user, said navigation data comprising a first and second geographical location;
(b) interrogating a first database storing merchants information to identify one or more candidate merchants using its geographic location and the electronic request;
(c) transmitting the merchant information of the one or more candidate merchants to the communication device, the merchant information comprising a geographic location of the candidate merchant.

The computer-implemented method may further comprise operations which the computer server is configured to perform as described above.

The term “automatic” is used in this document to refer to a process which is performed substantially without human involvement, save possibly for initiation of the process.

As used in this document, the term “payment card” refers to any cashless payment device associated with a payment account, such as a credit card, a debit card, a prepaid card, a charge card, a membership card, a promotional card, a frequent flyer card, an identification card, a gift card, and/or any other device that may hold payment account information, such as mobile phones, Smartphones, personal digital assistants (PDAs), key fobs, transponder devices, NFC-enabled devices, and/or computers.

### BRIEF DESCRIPTION OF THE DRAWINGS

Embodiments of the invention will now be described for the sake of non-limiting example only, with reference to the following drawings in which:

FIG. 1 shows schematically a computerized network which is suitable to perform the method which is an embodiment;

FIG. 2 shows schematically another computerized network which is suitable to perform the method which is another embodiment;

FIG. 3 is a flow diagram of a method which is an embodiment;

FIG. 4 shows the sub-operations in a possible realization of a operation of FIG. 3;

FIG. 5 shows the technical architecture of a computer server of the computerized network of FIG. 1; and

FIG. 6 shows the technical architecture of a communication device of the computerized network of FIG. 1.

### DETAILED DESCRIPTION

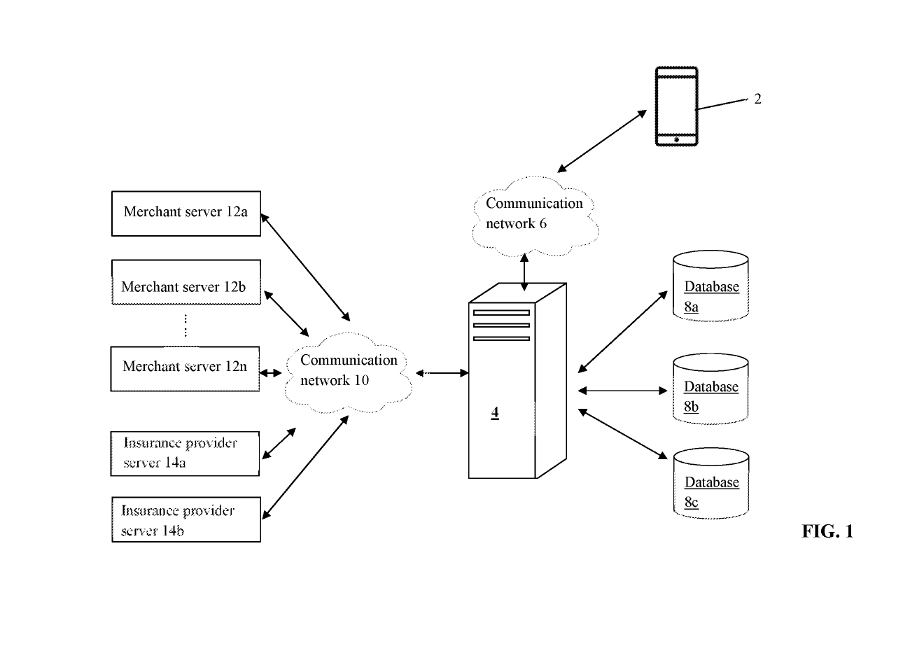

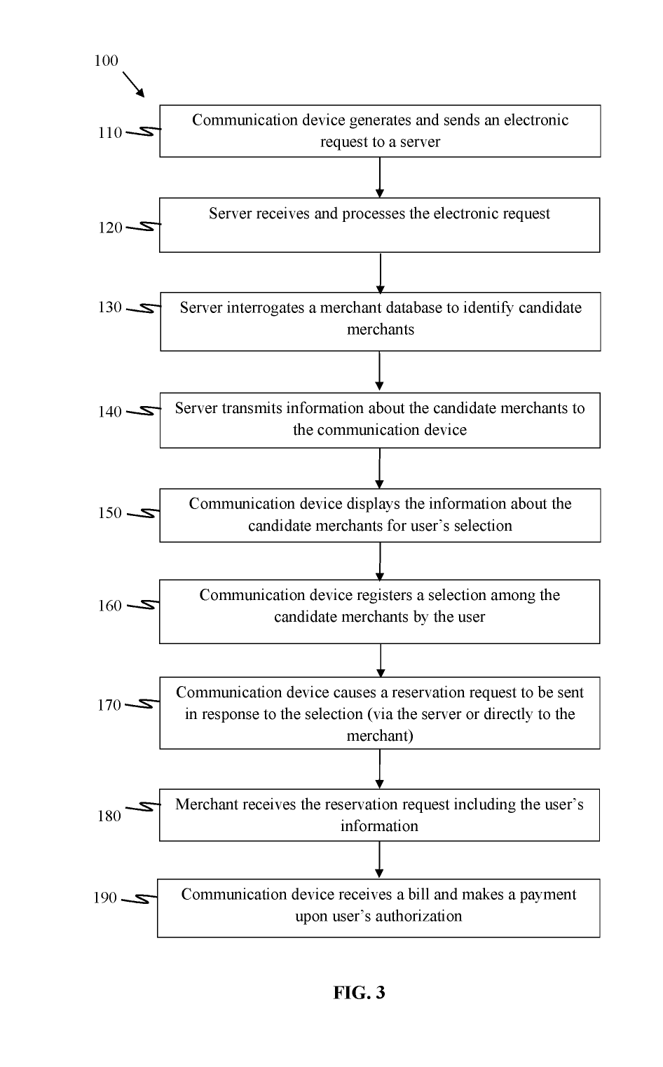

Referring to FIG. 1, a computerized network is shown which is suitable for performing a method of an embodiment as illustrated by FIG. 3. The computerized network comprises a communication device 2 associated with a user. The communication device may for example be a smartphone, a smart watch, a music player (e.g. MP3), a personal digital assistant (PDAs), a GPS unit of the user or the like.

The communication device 2 is remote from a computer server 4 and has a communication module such as a wireless interface for two-way communication with the computer server 4 via a communication network 6. In this embodiment, the computer server 4 has access to three databases: a merchant database 8a, a promotion database 8b, and a third-party database 8c, which will be described in more detail below.

As shown in FIG. 1, the computer server 4 may further be in communication with a communication network 10. Under the communication network 10, the computer server 4 is in two-way communication with a plurality of merchants' servers 12a, 12b, 12n, and third-party servers such as insurance provider servers 14a, 14b. It envisaged that merchants will provide automatically accessible information about their goods or service and availability data. A merchant may for example provide this via an application program interface on the merchant server 12a server operated by the merchant. This data can be used to populate the merchant database 8a and promotion database 8b.

The communication networks 6, 10 may be any types of network, for example, virtual private network (VPN), the Internet, a local area and/or wide area network (LAN and/or WAN), a wi-fi network, or a 3G or 4G telecommunication network.

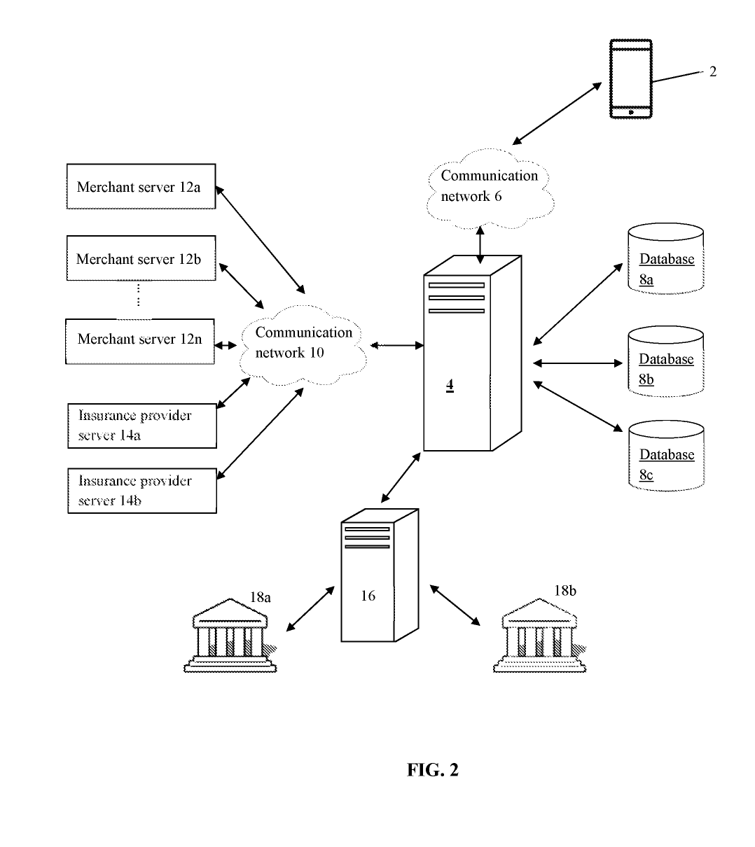

In another embodiment as shown in FIG. 2, the computerized-network may further comprise a payment network server 16. The computer server 4 is associated with a payment network, and in particular, it is in communication with a payment network server 16. Non-limiting examples of the payment network are a payment card type of network such as the payment processing network operated by MasterCard, Inc. The payment network server 16 handles payment transactions involving a payment card. In this example, upon receiving a request from an acquirer bank 18a, the payment network server 16 contacts an issuer bank 18b which issued the payment card to effect the payment transaction upon a cardholder's (e.g. the user's) authorization. The user's authorization may be communicated to the payment network direct by communication device 2 of the user or via the computer server 4.

FIG. 3 illustrates a flow of an exemplary method 100 of the present disclosure.

In operation 110, the communication device 2 generates an electronic request for goods or services and transmits the electronic request to the computer server 4. The electronic request is generated automatically upon the communication device 2 receiving an activation signal, for example, upon detecting a pre-defined condition of the vehicle.

In this example, the activation signal is generated by a tyre-pressure sensor of the user's vehicle. The tyre-pressure sensor is communicatively coupled to the communication device 2. For example, a dashboard of the vehicle (or any other on-board diagnostic system which monitors various parameters of the vehicle) which receives data from the tyre-pressure sensor coupled thereto may be configured to wirelessly communicate with the communication device 2 based on the data received. Upon the measured tyre-pressure falling below a pre-defined threshold, the communication device 2 automatically generates an electronic request which is indicative of a need for vehicle repair/maintenance services. The electronic request is then automatically transmitted to the computer server 4 via the communication network 6. In another example, the pre-define condition of the vehicle may be associated with a low-fuel level of the vehicle, overheat of the vehicle engine, etc.

In a particular example, a low-fuel alert may be generated by a positioning system (e.g. a GPS system, a GLONASS system, a GALILEO system or a BeiDou-2 system) of the vehicle using an estimate of the fuel use based on historical travelling data. The electronic request accordingly comprises information of a type of the goods or services required by the user.

In another example, the activation signal is generated by a sensor unit, for example, by a smart watch wearable by a user, which measures a physical parameter of the user, such as a heart rate and/or blood pressure. The sensor unit may be coupled to the communication device 2 via Bluetooth or any other wireless communication protocol. In one embodiment, upon the measured blood pressure or heart rate exceeding a certain threshold, the communication device detects the activation signal and automatically generates an electronic request for emergency medical services.

In a further embodiment, the activation signal is generated by an input actively initiated by the user, such as the user manually input through an input device of the communication device 2 requesting a type of goods or services.

The electronic request is generated further using navigation data associated with the user. In this example, the navigation data comprises a starting and destination location input by the user. In one embodiment, the navigation data is received from a positioning unit, such as a geo-location module 230c, of the communication device 2. In this example, the navigation data comprises a current geographic location detected by the geo-location module and a destination location (such as a postal code of the destination) entered by the user via an input device of the communication device 2. In a variant, the communication device 2 may receive the navigation data wirelessly from an on-board vehicle position tracking system (e.g. a GPS system, a GLONASS system, a GALILEO system or a BeiDou-2 system).

In some embodiments, the communication device 2 may store or receive personal information of the user such as user's payment information, a user's identity or a user's age. The electronic request is generated further using the personal information, and transmitted to the computer server 4.

In operation 120, the computer server 4 receives the electronic request via the communication network 6. In some embodiments, the computer server 4 may process the request to identify the type of goods or services required by the user.

In operation 130, the computer server 4 is configured to interrogate the merchant database 8a to obtain information about merchants which offer the type of goods or services requested by the user. The merchant database 8a stores merchant information such as information on goods or service provided by the merchant and a geographic location of the merchant. The merchant information may further comprises availability data about the merchants. The availability data indicates the candidate merchant's capacity in providing the goods or services during a pre-defined time slot. For example, the availability data may comprises a list of time-slots which the merchant has the ability to supply goods or services. The merchant database 8a may further store merchant information such as opening hours, contact details or the like. The server 4 may identify one or more candidate merchants based on a distance between its geographic location and a route connecting the starting and destination location, as well as a type of goods or services provided by the merchant.

The computer server 4 may interrogate additional databases such as the promotion database 8b to identify the candidate merchants in response to the request by the user. The promotion database 8b stores promotion information associated with merchants to supply goods or services. Such information may be offers by merchants to supply goods or services, and/or privileges made available for customers for payments made with a pre-define range of payment cards. For example, privileges are offered for payments made by a certain type of credit card, or those issued by a certain issuing bank. The computer server 4 may identify the one or more candidate merchants based on the promotion provided, in particular, if the merchant offers a promotion that is potentially applicable to the user based on the user's payment information.

The computer server 4 may further interrogate a third-party database 8c to identify the candidate merchants. The third-party database 8c stores information about third parties, such as insurance providers, who may offer payments for the goods or services supplied to the user. The payments may be in full or in part for the goods or services which qualify a corresponding insurance coverage.

The computer server 4 may retrieve the availability data associated with each of the candidate merchants from respective merchant servers 12a, 12b, 12n. It is envisaged that such availability data may be populated by the merchant servers 12a, 12b, 12n and stored in the merchant's database 8a which is updated automatically in real-time or at a time interval. In that case, it is not required for the computer server 4 to communicate with the merchant servers 12a, 12b, 12n to obtain the availability data.

In operation 140, the computer server 4 transmits necessary information including the merchant's location and the availability data about the candidate merchants to the communication device 2 of the user. In operation 150, such information is displayed for the user to select a merchant he/she is interested in visiting or engaging among the candidate merchants. In a preferred embodiment, the user may specify a desired time slot with the merchant for the reservation. For example, a list of available time slots pre-defined by the merchant may be populated for the user's selection. In another example, the user will be allowed to request a customized time slot which may be sent to the merchant's server 12a for confirmation by the merchant subject to its availability. In operation 160, the communication device 2 registers the user's selection of the merchant. The user's selection may be registered by the user making an active input, for example, by registering a user's action on an input terminal of the communication device 2. In some embodiments, an active input from the user may not be required. For example, in the absence of the user's action, a default candidate merchant (e.g. a candidate merchant which has the optimal availability or which is nearest to the current location of the user may be automatically selected) may be registered as the user's selection.

In operation 170, a reservation request to be sent in response to the selection made by the user in operation 170. This may be performed by the communication device 2 sending a command to the computer server 4 requesting the server 4 to send the reservation request to the merchant's server 12a. In a variant, this may be performed by the communication device sending a reservation request directly to the merchant server 12a via a communication network (not shown). The communication device 2 may further determine a navigation route which connects the starting, destination location and merchant's geographic location. The navigation route may be determined based an estimated travelling time, distance, traffic conditions and/or the like. An optimal navigation route, for example the one with the shortest travelling time to the merchant en route to the destination location, may be automatically calculated and recommended to the user.

In operation 180, the merchant server 12a receives the reservation request from the user, and reserves a corresponding goods or services for the user. The reservation request may further comprise personal information associated with the user, such as an identity of the user, payment information of the user, and/or general preferences of the user relating to the goods or services which the merchant provides. The merchant may then use this information to prepare the goods or services according to the user's preference.

The communication device 2 may further assist with a payment transaction with the merchant for the goods or services provided to the user.

In operation 190, the communication device 2 may receive a bill from the merchant server and cause a payment for the bill to be processed over a payment network to effect the payment. For example, the communication device 2 may store credit card information of the user which may be communicated to the payment network server 16 for processing the payment.

In another example, the communication device 2 communicates with the payment network serve 16 via the computer server 4. In another example, the communication device 2 may store identity data of the user for a payment system at which the user has previously registered, such as the digital or mobile wallet offered by the MasterPass™ system. The user may use a MasterPass™ ID and password to authenticate his/her identity before causing the payment transaction to be processed by the payment network server 16. In another embodiment, the payment may be made using payment details which are held on file at another server (not shown) with which the communication device 2 is in communication. The card details and payment amount, as well as other information typically used to complete a payment transaction, may be passed from the server to a payment gateway in order to process the transaction.

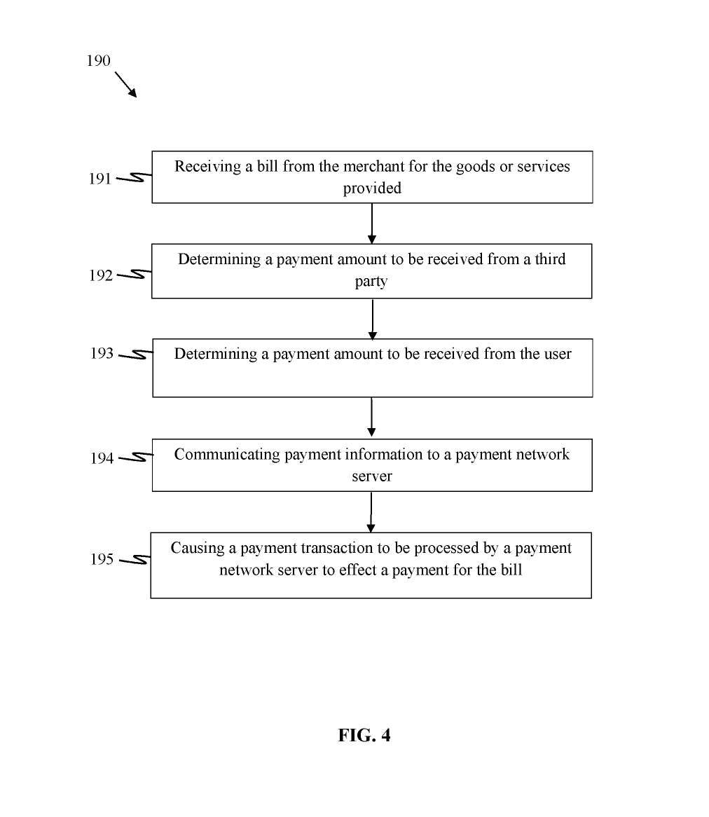

In one embodiment, one possibility of performing operation 190 is illustrated in FIG. 4. In sub-operation 191, the communication device 2 receives a bill showing an amount payable by the user to the merchant in respect of the goods or services provided. The bill may be received by the communication device 2 directly from the merchant's server 12a, or via the computer server 4.

In one embodiment, the bill has a first and second payment amount to be received from the user and a third party respectively. For example, the computer server 4 receives a bill, and determines a payment amount to be received from a user and an insurance provider, respectively. In particular, the computer server 4 receives insurance data of the user and determines a payment amount to be received from the insurance provider based on the insurance data. A payment amount receivable from the user may be determined based on a balance of the bill owed to the merchant. In another example, the computer server 4 is configured to determine a payment amount to be received from the user based on the insurance data then calculate the amount to be received from the insurance provider based on the balance.

Alternatively or additionally, the computer server 4 transmits the bill and the user's personal information to the insurance provider server 14a. The insurance provider server 14a determines or validates the payment amount payable by the insurance provider and notifies the computer server 4. The computer server 4 then communicates the balance amount to the communication device 2 and optionally causes a payment transaction to be carried out over the payment network as described above. Similarly, the computer server 4 may request the insurance provider server 14a to prepare and make a payment transaction for the amount payable over a same or different payment network.

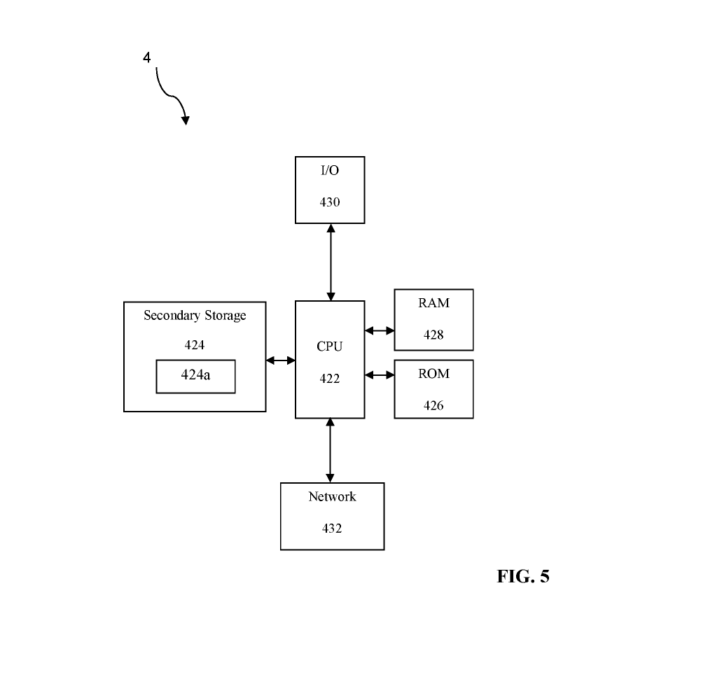

FIG. 5 is a block diagram showing a technical architecture of the computer server 4.

The technical architecture includes a processor 422 (which may be referred to as a central processor unit or CPU) that is in communication with memory devices including secondary storage 424 (such as disk drives), read only memory (ROM) 426, random access memory (RAM) 428. The processor 422 may be implemented as one or more CPU chips. The technical architecture may further comprise input/output (I/O) devices 430, and network connectivity devices 432.

The secondary storage 424 is typically comprised of one or more disk drives or tape drives and is used for non-volatile storage of data and as an over-flow data storage device if RAM 428 is not large enough to hold all working data. Secondary storage 424 may be used to store programs which are loaded into RAM 428 when such programs are selected for execution.

In this embodiment, the secondary storage 424 has a processing component 424a comprising non-transitory instructions operative by the processor 422 to perform various operations of the method of the present disclosure. The ROM 426 is used to store instructions and perhaps data which are read during program execution. The secondary storage 424, the RAM 428, and/or the ROM 426 may be referred to in some contexts as computer readable storage media and/or non-transitory computer readable media.

I/O devices 430 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 432 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 432 may enable the processor 422 to communicate with the Internet or one or more intranets. With such a network connection, it is contemplated that the processor 422 might receive information from the network, or might output information to the network in the course of performing the above-described method operations. Such information, which is often represented as a sequence of instructions to be executed using processor 422, may be received from and outputted to the network, for example, in the form of a computer data signal embodied in a carrier wave.

The processor 422 executes instructions, codes, computer programs, scripts which it accesses from hard disk, floppy disk, optical disk (these various disk based systems may all be considered secondary storage 424), flash drive, ROM 426, RAM 428, or the network connectivity devices 432. While only one processor 422 is shown, multiple processors may be present. Thus, while instructions may be discussed as executed by a processor, the instructions may be executed simultaneously, serially, or otherwise executed by one or multiple processors.

Although the technical architecture is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 220 to provide the functionality of a number of servers that is not directly bound to the number of computers in the technical architecture 220. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third-party provider.

It is understood that by programming and/or loading executable instructions onto the technical architecture, at least one of the CPU 422, the RAM 428, and the ROM 426 are changed, transforming the technical architecture in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

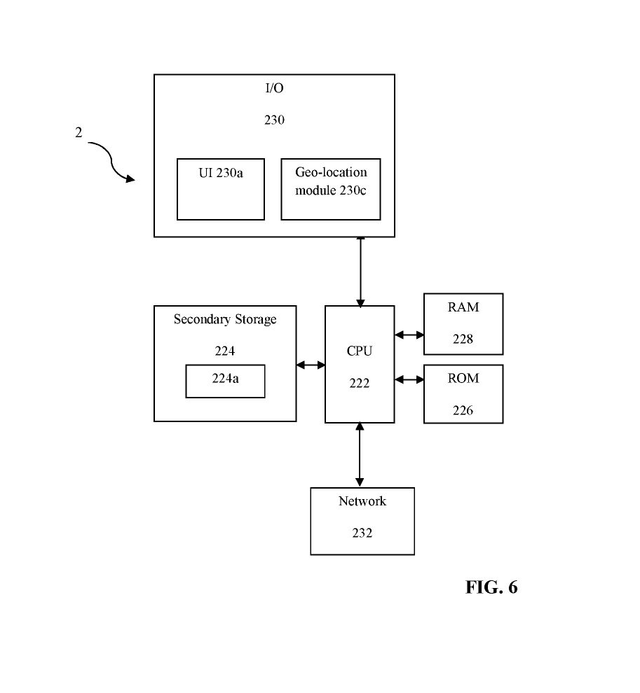

FIG. 6 is a block diagram showing a technical architecture of the communication device 1. The technical architecture includes a processor 222 (which may be referred to as a central processor unit or CPU) that is in communication with memory devices including secondary storage 224 (such as disk drives or memory cards), read only memory (ROM) 226, random access memory (RAM) 228. The processor 222 may be implemented as one or more CPU chips. The technical architecture further comprises input/output (I/O) devices 230, and network connectivity devices 232.

The I/O devices comprise a consumer interface (UI) 230a and a geolocation module 230c. The UI 230a may comprise the screen 3 in the form of a touch screen, the keyboard 4, a keypad or other known input device. The camera 2 allows a consumer to capture images and save the captured images in electronic form. The geolocation module 230c is operable to determine the geolocation of the communication device using signals from, for example, global positioning system (GPS) satellites.

The secondary storage 224 is typically comprised of a memory card or other storage device and is used for non-volatile storage of data and as an over-flow data storage device if RAM 228 is not large enough to hold all working data. Secondary storage 224 may be used to store programs which are loaded into RAM 228 when such programs are selected for execution.

In this embodiment, the secondary storage 224 has a processing component 224a, comprising non-transitory instructions operative by the processor 222 to perform various operations of the method of the present disclosure. The ROM 226 is used to store instructions and perhaps data which are read during program execution. The secondary storage 224, the RAM 228, and/or the ROM 226 may be referred to in some contexts as computer readable storage media and/or non-transitory computer readable media.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Whilst the foregoing description has described exemplary embodiments, it will be understood by those skilled in the art that many variations of the embodiment can be made within the scope and spirit of the present invention. For example, the communication networks 6, 10 may be a connected communication work. For another example, the method may be used for a pedestrian who travels by foot and the merchants are identified based on a mode of travel of the user, i.e. the candidate merchants are identified among those within a walking distance.

1. A communication device, the communication device comprising a processor and a data storage device storing computer program instructions,
the computer program instructions being operative, to cause the processor to:
(a) receive navigation data associated with a user, said navigation data comprising first and second geographic locations;
(b) upon receiving an activation signal, generate an electronic request using the activation signal and the navigation data, said electronic request encoding a request for goods or services corresponding to the activation signal;
(c) transmit the electronic request to a computer server to obtain merchant information of one or more candidate merchants; and
(d) receive the merchant information of the one or more candidate merchants, the merchant information comprising at least one geographic location of the one or more candidate merchants.

2. The communication device according to claim 1, wherein the merchant information comprises availability data about the one or more candidate merchants; the availability data being indicative of the candidate merchant's capacity in providing the goods or services during a pre-defined time slot.

3. The communication device according to claim 1, wherein the data storage device storing computer program instructions operative to cause the processor to:
(e) register a selection among the one or more candidate merchants by the user; and
(f) cause a reservation request to be transmitted to a merchant's server in response to the selection.

4. The communication device according to claim 1, wherein the communication device comprises a positioning unit configured to determine a geographic location of the communication device and operation (a) comprises receiving the first geographic location from the positioning unit.

5. The communication device according to claim 1, wherein the activation signal is generated by a sensor unit communicatively coupleable to the communication device.

6. The communication device according to claim 5, wherein the sensor unit comprises a vehicle sensor coupled to a vehicle, wherein said activation signal is generated upon a pre-defined condition of the vehicle being detected by the vehicle sensor, wherein said pre-defined condition is indicative of a need for vehicle maintenance.

7. The communication device according to claim 5, wherein the sensor unit is configured to measure a physical parameter of the user, said activation signal being generated upon the measured physical parameter exceeding a pre-defined range.

8. The communication device according to claim 1, wherein the activation signal is generated by an input initiated by the user.

9. The communication device according to claim 1, wherein each of the one or more candidate merchants is identified using its geographic location and the electronic request.

10. The communication device according to claim 1, wherein each of the one or more candidate merchants is identified based on a distance between its geographic location and a route connecting the first and second geographic location.

11. The communication device according to claim 1, wherein the data storage device storing computer program instructions being operative to cause the processor to receive personal information of the user, wherein the electronic request is generated further using the personal information.

12. The communication device according to claim 3, wherein the data storage device storing computer program instructions being operative to cause the processor to receive personal information of the user, wherein said reservation request comprises the personal information.

13. The communication device according to claim 11, wherein the personal information comprises at least one of (i) payment information associated with the user, (ii) an identity of the user, and (iii) an age of the user.

14. The communication device according to claim 1, wherein the data storage device storing computer program instructions being operative to cause the processor to:
(g) receive a bill, from a merchant's server, for goods or services supplied to the user by the merchant; and
(h) upon an authorization by the user, cause a payment transaction to be processed by a payment network server to effect a payment for the bill.

15. The communication device according to claim 1, wherein the computer program instructions being operative to cause the processor to determine a navigation route which connects the first geographic location, the second geographic location and the at least one geographic location of the one or more candidate merchants.

16. A computer-implemented method of identifying a merchant, the method comprising a communication device:
(a) receiving navigation data associated with a user, said navigation data comprising first and second geographic locations;
(b) upon receiving an activation signal, generating an electronic request using the activation signal and the navigation data, said electronic request encoding a request for goods or services corresponding to the activation signal;
(c) transmitting the electronic request to a computer server to obtain merchant information of one or more candidate merchants; and
(d) receiving the merchant information of the one or more candidate merchants, the merchant information comprising at least one geographic location of the one or more candidate merchants.

17. The computer-implemented method according to claim 16, wherein the merchant information comprises availability data about the one or more candidate merchants; the availability data being indicative of the candidate merchant's capacity in providing the goods or services during a pre-defined time slot.

18. The computer-implemented method according to claim 16 further comprising:
(e) registering a selection among the one or more candidate merchants by the user; and
(f) causing a reservation request to be transmitted to a merchant's server in response to the selection.

19. The computer-implemented method according to claim 16, wherein the communication device comprises a positioning unit configured to determine a geographic location of the communication device, the method comprising receiving the first geographic location from the positioning unit.

20. The computer-implemented method according to claim 16, wherein the activation signal is generated by a sensor unit communicatively coupleable to the communication device.

21. The computer-implemented method according to claim 20, wherein the sensor unit comprises a vehicle sensor coupled to a vehicle, wherein said activation signal is generated upon a pre-defined condition of the vehicle being detected by the vehicle sensor, wherein said pre-defined condition is indicative of a need for vehicle maintenance.

22. The computer-implemented method according to claim 20, wherein the sensor unit is configured to measure a physical parameter of the user, said activation signal being generated upon the measured physical parameter exceeding a pre-defined range.

23. The computer-implemented method according to claim 16, wherein the activation signal is generated by an input initiated by the user.

24. The computer-implemented method according to claim 16, wherein each of the one or more candidate merchants is identified using its geographic location and the electronic request.

25. The computer-implemented method according to claim 16, wherein each of the one or more candidate merchants is identified based on a distance between its geographic location and a route connecting the first and second geographic location.

26. The computer-implemented method according to claim 16 further comprising the communication device receiving personal information of the user, wherein the electronic request is generated further using the personal information.

27. The computer-implemented method according to claim 18 further comprising the communication device receiving personal information of the user, wherein said reservation request comprises the personal information.

28. The computer-implemented method according to claim 26, wherein the personal information comprises at least one of (i) payment information associated with the user, (ii) an identity of the user, and (iii) an age of the user.

29. The computer-implemented method according to claim 16 further comprising the communication device:
(g) receiving a bill, from a merchant's server, for goods or services supplied to the user by the merchant; and
(h) upon an authorization by the user, causing a payment transaction to be processed by a payment network server to effect a payment for the bill to the merchant.

30. The computer-implemented method according to claim 16 further comprising the communication device determining a navigation route which connects the first geographic location, the second geographic location and the at least one geographic location of the one or more candidate merchants.

31. A computer program product comprising computer program instructions,
the computer program instructions being operative, when implemented by a processor of a communication device, to cause the processor to:
(a) receive navigation data associated with a user, said navigation data comprising first and second geographic locations;
(b) upon receiving an activation signal, generate an electronic request using the activation signal and the navigation data, said electronic request encoding a request for goods or services corresponding to the activation signal;
(c) transmit the electronic request to a computer server to obtain merchant information of one or more candidate merchants; and
(d) receive the merchant information of the one or more candidate merchants, the merchant information comprising at least one geographic location of the one or more candidate merchants.

32. The computer program product according to claim 31 in which the computer program instructions are operative to cause the processor to perform a method according to claim 16.
